(19) United States
(12) Patent Application Publication
(10) Pub. No.: US 2016/0272112 A1
(43) Pub. Date: Sep. 22, 2016

(54) Detection and Security System for Occupants in Vehicles

(71) Applicant: CarEye LLC, Houston, TX (US)

(72) Inventors: Rocco DeGrazia, Houston, TX (US); Ahmed Megahed, Houston, TX (US)

(73) Assignee: CarEye LLC, Houston, TX (US)

(21) Appl. No.: 14/661,049

(22) Filed: Mar. 18, 2015

(51) Int. Cl. B60Q 9/00; H02S 10/20; G01J 5/00; H01M 10/46; B60R 21/015; G01S 19/24

(52) U.S. Cl. CPC B60Q 9/00; B60R 21/01534; B60R 21/01536; B60R 21/01538; G01S 19/24; G01J 5/0025; H01M 10/465; H02S 10/20

(57) ABSTRACT

A method for notifying a user regarding a critical condition in a vehicle is presented. A monitoring device is positioned on a surface of a vehicle within an appropriate range of distance from a reference point in the vehicle. The monitoring device includes an infrared sensor for detecting radiation emitted from animate objects in a vehicle. A temperature of an interior of the vehicle is regularly measured. The interior of the vehicle is checked for any radiation emitted in order to detect a presence of an occupant located within the vehicle. Upon determining the presence of the occupant, verification is made whether the temperature of an interior of the vehicle is at a threshold temperature, whereupon a notification message is generated to a user associated with the monitoring device. Confirmation of receipt of the message may be required before the monitoring device attempts to alert alternate emergency contact numbers.

### BACKGROUND OF THE INVENTION

(1) Field of the Invention

The illustrative embodiments relate generally to an improved system for detecting critical data about environmental conditions in a vehicle, and more particularly, to a method and apparatus for detecting the presence of children and other occupants in the vehicle under dangerous environmental conditions, and effectively alerting a set of individuals of their presence in the vehicle.

2. Background Art

Every year, many tragic fatalities occur to infants, young children, and/or pets that are left alone in unattended vehicles. They become exposed to various environmental conditions that are dangerous to their well-being. Oftentimes, the weather conditions become too extreme for infants, young children, or pets, which are usually left unattended and restrained without means of assisting themselves. A far too common occurrence is that the caretaker for various reasons such as fatigue, stress, or basic human error, forgets to remove an infant or child who is restrained in a car seat in a vehicle on a hot day. Within minutes, a car that that has been powered off with an infant or young child inside, without any air conditioning and closed windows, may become so hot so as to become extremely dangerous to the life and well-being of that infant or child. It is estimated that dozens of children die each year due these types of deaths. Similarly, pets are often kept in vehicles in conditions that are not suitable to their health as well, and may overheat or die.

These fatalities are tragic and destroy the lives of many individuals. Even if a fatality does not occur, the sensitive individuals and living beings kept in vehicles through human error or mistake may endure negative, long lasting side effects from residing for too long within a vehicle with the presence of dangerous conditions.

There does exist a limited number of disclosures presented in prior art to address this matter. Notwithstanding, as previously stated, the rate of deaths of infants and pets and other loved ones remains too high despite these prior art publications.

Methods and devices as seen in prior art publications have included methods such as providing weight and proximity sensors that are attached directly to a car seat. Other publications describe notifying a responsible party of the occupant in a vehicle using a device located in a vehicle, but the prior art was limited by the device requiring the responsible party to be located within a limited proximity to the vehicle. In cases where a child is in a car seat without an attached sensor or where the predetermined proximity is exceeded by the set of individuals, these methods would entirely fail to detect or notify others of occupancy in a vehicle, and thus fail to prevent a tragic death or serious injury to that occupant restrained in the vehicle.

Thus, the problem is ongoing and far too prevalent in spite of the previous attempts. There is still a great need for an improved method and apparatus that will properly address the potentially lethal combination of dangerous environmental conditions in the interior of a vehicle, such as, without limitation, extreme heat, cold, carbon monoxide, or smoke, and the presence of a helpless occupant left unattended in the vehicle in such conditions.

### BRIEF SUMMARY OF THE INVENTION

The presently disclosed subject matter was devised in view of these and other problems and features in association with the conventional art. An illustrative embodiment provides a method and system for notifying an owner regarding a critical condition in a vehicle wherein an occupant of interest has been detected in the vehicle. A monitoring device that monitors dangerous environmental conditions within the vehicle, such as extreme heat or cold, is described herein.

The method and system for utilizing the above-mentioned monitoring device, includes positioning the monitoring device on a surface of a vehicle within an appropriate range of the occupant. In an illustrative embodiment, the monitoring device is configured to include an infrared sensor as well as a temperature detection device. The infrared sensor is utilized to detect the presence of an occupant in the vehicle. The temperature detection device is used to measure the interior temperatures of the vehicle to determine whether the temperatures are in a range that would be considered by one of ordinary skill in the art to be dangerous to an occupant left alone in a vehicle.

The apparatus includes an independent power source to ensure the safety device remains active when the power source of the vehicle has been turned off. In some embodiments, the power source is solar powered. The method further includes measuring the temperature of the vehicle using the temperature detection device, scanning the interior of the vehicle to determine a presence of an occupant within the vehicle using the infrared sensor, and notifying a set of individuals associated with the safety device upon determining that the range of temperatures within the vehicle is considered dangerous to the health of the occupant in the vehicle. The method and system further requires confirmation within a pre-determined range of time from the set of individuals that the notification message is received and recognized, whereby if no confirmation is provided by the set of individuals, the monitoring device proceeds to notify an alternate emergency number associated with the monitoring device.

### BRIEF DESCRIPTION OF THE SEVERAL VIEWS OF THE DRAWINGS

The novel features believed characteristic of the invention are set forth in the appended claims. The illustrative embodiments, as well as a preferred mode of use, further objectives and advantages thereof, will best be understood by reference to the following detailed description when read in conjunction with the accompanying drawings, wherein:

FIG. 1 is a block diagram of an environmental condition monitoring unit for a vehicle in accordance with an illustrative embodiment;

FIG. 2 is a block diagram of an environmental condition monitoring unit that operates in conjunction with integrated functional elements existing within a vehicle in accordance with an illustrative embodiment;

FIG. 3 is an illustration of a vehicle under circumstances where a car seat is included in the vehicle as well as an environmental condition monitoring unit in accordance with an illustrative embodiment;

FIG. 4 is an illustration of a vehicle under circumstances where the occupant in a vehicle is a pet and the environmental condition monitoring unit is included in the vehicle in accordance with an illustrative embodiment;

FIG. 5 is a flowchart of a method associated with an environmental condition monitoring unit in a vehicle to detect occupants under hazardous conditions in accordance with an illustrative embodiment; and

FIG. 6 is an illustration of an alert message as received by a user of the environmental condition monitoring unit in a vehicle in accordance with an illustrative embodiment.

### DETAILED DESCRIPTION OF THE INVENTION

Occupants who may be inadvertently left in vehicles often end up facing dangerous conditions and yet are helpless to assist themselves. This is the case for many occupants, such as young children and pets. Under these circumstances, a goal of the illustrative embodiments described herein is to provide detection and notification as timely as possible to a set of individuals about the occupants in such a vehicle.

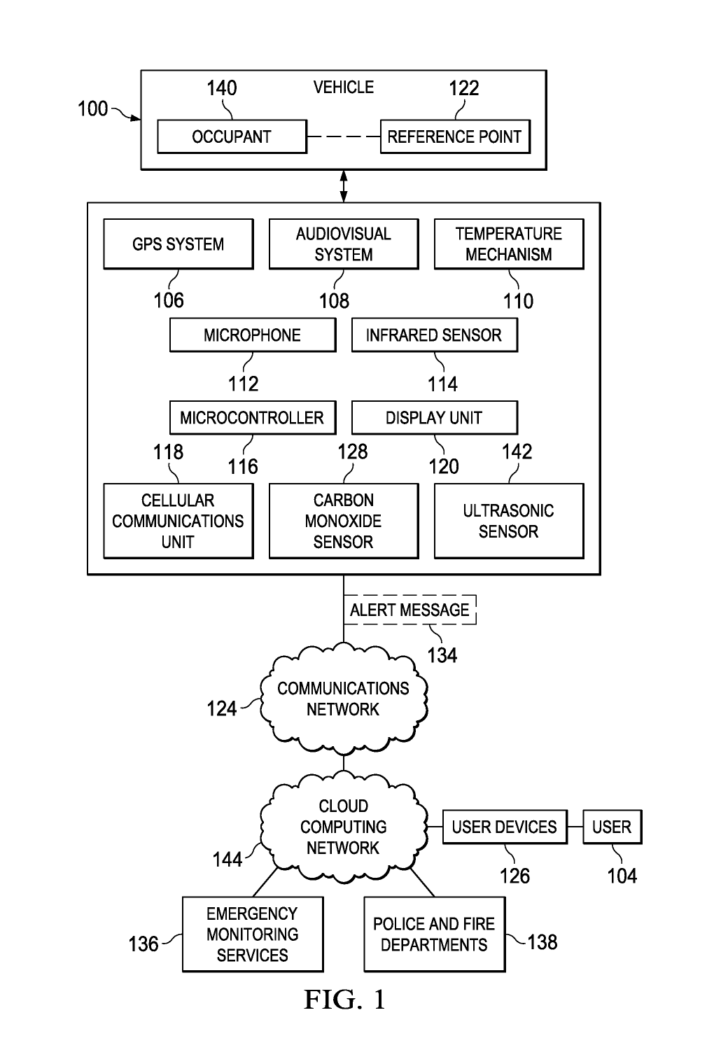

Referring now to FIG. 1, a block diagram of an environment condition monitoring unit in a vehicle is depicted in accordance with an illustrative embodiment. Vehicle 100 may be any type of automobile. It is known to one of ordinary skill to be any type of automobile, including without limitation, trucks, vans, sport utility vehicles, sedans, or any automobile regardless of size or number of seats. Vehicle 100 may have two doors, four doors, or any combination and variation thereof.

Vehicle 100 includes an environmental condition monitoring unit (also known as ECMU) 102 in an illustrative embodiment. ECMU 102, in addition to other capabilities and benefits to a user, may operate as a safety monitoring and notification device. ECMU 102 detects dangerous conditions so as to provide notification to the owner and other individuals if required that the conditions in vehicle 100 may be critical to an occupant who has been detected to be located within vehicle 100.

ECMU 102 may be attached to any surface of vehicle 100, including a glass surface, a leather surface, a plastic surface, or cloth surface. ECMU 102 is positioned within an understood range from a reference point, such as reference point 122 within vehicle 100. User 104 most likely chooses to purchase ECMU 102, in circumstances, where user 104 regularly transports infants, young children, or pets in a vehicle. Thus, user 104 may be aware of the risk of fatality to certain occupants if forgotten in a vehicle when temperatures become too extreme.

In one illustrative embodiment, user 104 will knowingly place ECMU 102 within a range of distance for proper operation of ECMU 102 from a reference point, such as reference point 122 that is relevant to user 104 for ECMU 102 to monitor. A reference point, as used herein, may be a location within vehicle 100 that user 104 tends to position occupants of interest to user 104. Reference point 122 may be, without limitation, a car seat, a booster seat, or any other type of seat provided for infants and young children in vehicle 100. In circumstances where occupant 140 is not a child, infant, or person of any kind, reference point 122 may be any fixed position in vehicle 100. In one illustrative embodiment, reference point 122 is positioned within a certain range from ECMU 102 so that the embedded infrared sensor 114 is capable of detecting occupants located at or near reference point 122. Notwithstanding, in order to suit the placement needs of user 104 within vehicle 100, infrared sensor 114 may be positioned several feet away from reference point 122. Infrared sensor 114 may detect occupants located at reference point 122 at a variety of distances. Nothing herein is meant to limit the capabilities of infrared sensor 114 of detecting occupants at any distance from infrared sensor 114.

ECMU 102 may be positioned throughout vehicle 100 as needed to suit the needs of user 104. ECMU 102 may be located on any surface of vehicle 100, including but not limited to, cloth, plastic, glass, metal, or any other type of material located in a vehicle known to one of ordinary skill.

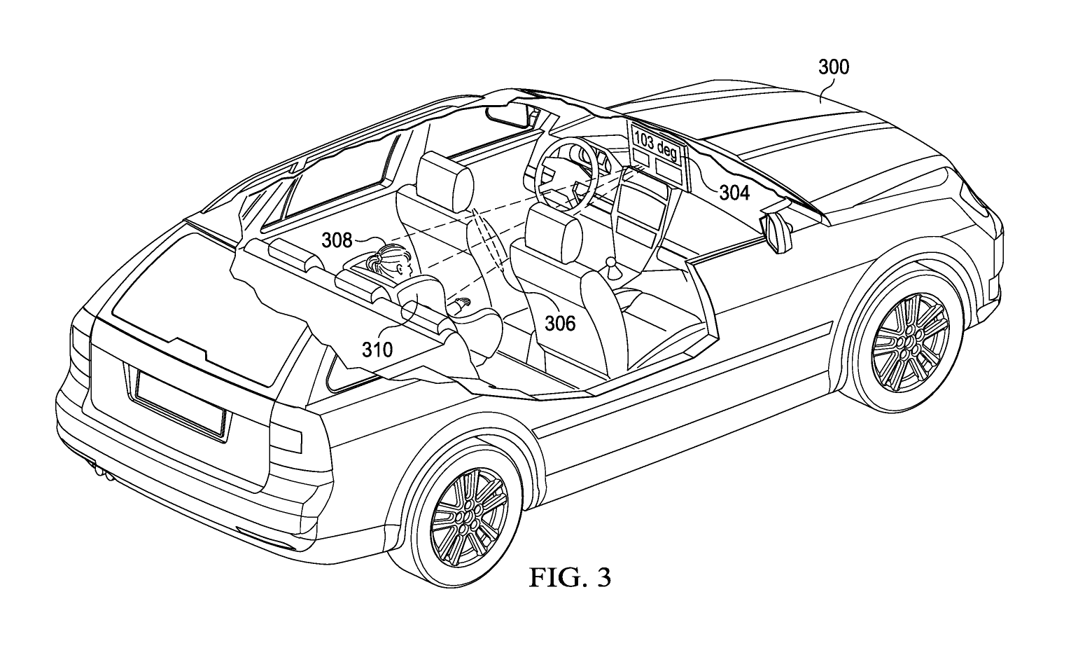

FIG. 3 further illustrates the positioning of ECMU 102 within the field of view of infrared sensor 114. Field of view, as used herein, refers to the area within range of detection for infrared sensor 114.

A reference point, such as reference point 122, when the reference point is a car seat, is usually located in the rear seating available in a vehicle. Car seats are rarely seen in the front seating of the interior of a vehicle as it is prohibited by most state and federal laws. Depending on the age of the infant or child in the car seat, a parent will locate a car seat on either the far right hand side or far left hand side of the rear of a vehicle's seating. When ECMU 102 is being positioned on a surface of vehicle 100, user 104 will be cognizant to position ECMU 102 so that infrared sensor 114 embedded within ECMU 102 is within the appropriate range or field of view for reference point 122. In some models of ECMU 102, ECMU 102 on its display unit 120 will have an indicating LED light that is meant to indicate to user 104 whether reference point 122 is within the field of view of infrared sensor 114 embedded within ECMU 102.

It is anticipated that ECMU 102 may also be positioned on the interior windshield of vehicle 100 or on either side windows located in the rear of vehicle 100. User 104 may choose to position ECMU 102 on side windows in the rear of the vehicle if user 104 is transporting a pet and the pet is located on the ground of vehicle 100 or other rear portion of vehicle 100. Thus, ECMU 102 may be better able to detect a pet that is either contained within an enclosure on the ground of vehicle 100 or in the rear of vehicle 100.

User 104 may also choose to position ECMU 102 on a side window or on a rear windshield or other location in the rear of the vehicle when user 104 transports a very young infant. Many parents are encouraged to keep their children in rear-facing car seats from the age of birth to at least one or two years of age. If the car seat is facing the rear of the vehicle, user 104 may elect to position ECMU 102 in vehicle 100 so as to detect occupant when such a rear-facing car seat is utilized.

Notably, ECMU 102 may be positioned to a surface of vehicle 100 according to the needs of user 104 and according to the layout of the interior of the vehicle. It is well-known that different vehicles may have different interior arrangements and ECMU 102 has added utility in that it can accommodate the variety of vehicles commercially available, since the ECMU 102 may be positioned on a variety of surfaces in the interior of a vehicle, such as vehicle 100.

ECMU 102 may also provide means for inputting the type and color of vehicle 100. This feature assists in identifying a vehicle, such as vehicle 100, if user 104 needs assistance in locating or recognizing which vehicle occupant 140 is restrained in. Microcontroller 116 may store such identifying data regarding vehicle 100. Display unit 120 may include any type of keyboard or number pad for entering relevant instructions and data into ECMU 102. Display unit 120 may include physical buttons and selectors or may be entirely a touch screen without physical buttons, or a hybrid of both, without limitation, as to the appearance of display unit 120 of ECMU 102.

The illustrative embodiments above disclose positioning a removable and mobile environmental condition monitoring unit, such as ECMU 102.

Additionally, in accordance with an illustrative embodiment, ECMU 102 includes global positioning system (GPS) 106, audio-visual system 108, temperature sensor 110, microphone 112, infrared sensor 114, and carbon monoxide sensor 128. These items are included as illustrative examples only of components of ECMU 102, and are not meant to limit additional components of ECMU 102. These components of ECMU 102 listed herein and others may be arranged in any order, design, or physical appearance within the ECMU 102.

In a preferred illustrative embodiment, ECMU 102 is configured to include infrared sensor 114. An infrared sensor measures infrared light radiating from objects within its field of view. Such infrared sensors are also known as passive infrared sensors.

All living objects emit heat energy in the form of radiation. Radiation is invisible to the human eye. Instead, radiation is emitted as infrared wavelengths, the radiation may be detected by various infrared sensors designed for such a purpose. An infrared sensor is usually mounted to a circuit board that then has a protective housing to protect the components of the circuit board and infrared sensor. In FIG. 1, infrared sensor 114 is included as a component of ECMU 102. Infrared sensor 114 detects the radiation emitted off of surrounding animated objects, including humans and pets. Infrared sensor 114 may be configured and calibrated to an appropriate corresponding calibration level so as to detect humans and pets. Calibration of infrared sensor 114 may be necessary so as to avoid triggering ECMU 102 if infrared sensor 114 detects smaller living objects in vehicle 100 that are not of critical importance to user 104, such as bugs or insects.

In order to enhance the capability and functionality of ECMU 102, in some embodiments, another sensor may be used in addition to infrared sensor 114. Ultrasonic sensor 142 may be a sensor that is used to detect occupant 140 utilizing the principles related to detecting ultrasonic waves emitted from occupant 140. As utilized by ECMU 102, ultrasonic sensor 142 may detect occupant 140 by sending and/or receiving sound waves and measuring the distance of an object from the ultrasonic sensor by virtue of the sound waves. An ultrasonic sound wave is an oscillating sound pressure wave with a frequency greater than the upper limit of the human hearing range. Thus, an ultrasonic transducer and/or transreceiver may emit sound waves that are inaudible to humans. Ultrasonic sensor 142 is configured to utilize ultrasonic waves to detect the presence of an occupant, such as occupant 140. An advantage offered by ultrasonic sensors, such as ultrasonic sensor 142, is that they are capable of detecting objects within a wide range area and that they do not require a direct line of sight to an occupant. In setting up the ECMU 102 that houses ultrasonic sensor 142, ECMU 102 may still be configured to transmit an ultrasonic pulse in a particular direction, such as the direction of reference point 122. If there is an object in the path of this pulse, part or all of the pulse will be reflected back to the transmitter as an echo and can be detected through the receiver path. By measuring the difference in time between the pulse being transmitted and the echo being received, it is possible to determine the distance. ECMU 102 may include both infrared sensor 114 and ultrasonic sensor 142 in some embodiments, or may solely include one sensor or another. Nothing herein is meant to limit the inclusion or addition of any other categories or types of sensors configured with ECMU 102 that may be utilized to detect occupant 140.

For example, ECMU 102 may include additional sensors and detectors that either operate individually in place of either infrared sensor 114 or ultrasonic sensor 142 or even in conjunction with infrared sensor 114 and ultrasonic sensor 142 to ensure maximum success in detecting occupant 140 under any circumstances. These sensors may include but are not limited to chemosensors and thermal imaging. Chemosensors are configured to detect a scent associated with people and animals. In some environmental circumstances and some applications, thermal imaging may be utilized as well in association with ECMU 102. Nothing herein limits the use of additional sensors capable of detecting other characteristic features of an animate occupant, such as, without limitation, sound detection or carbon dioxide detection of an occupant in vehicle 100.

Microcontroller 116 is essentially a small computer on a single integrated circuit that may be embedded in ECMU 102. Microcontroller 116 includes at least a processor, a core, programmable memory, with input/output ports. Microcontroller 116 is embedded in ECMU 102 and configured to provide real-time response to events in ECMU 102.

ECMU 102 is may be attached to a surface of vehicle 100 using permanent, semi-permanent, or temporary means of adhesion to suit the needs of user 104. In a preferred embodiment, ECMU 102 may be securely attached to a surface of vehicle 100 using, for example purposes only, a suction cup. A suction cup is an object that uses negative fluid pressure of air or water to adhere to nonporous surfaces and in the process creates a partial vacuum. Using a suction cup for means of adhering to a surface of vehicle 100 allows for user 104 to position ECMU 102 in multiple locations throughout vehicle 100 as needed. Furthermore, removable means, such as a suction cup, provides user 104 with the means to remove ECMU 102 and place in storage when user 104 chooses. Other means for adhering an attachable surface of ECMU 102 to a surface of vehicle 100 include means known to one of ordinary skill in the art, such as without limitation, adhesive tape of varying strengths and thicknesses, Velcro, metal fasteners such as screws and bolts, as well as glue and other commercially available adhesives that may bond ECMU 102 in a permanent or semi-permanent fashion to a surface of vehicle 100.

ECMU 102 includes display unit 120. Since ECMU 102 is an electronic device, ECMU 102 has housing to protect the components configured to operate within ECMU 102. Display unit 120 provides the key measurements and indicators provided by these elements included in ECMU 102. Since user 104 may position ECMU 102 anywhere within vehicle 100 that is convenient to user 104, display unit 120 may provide audio/visual measurements and indicators regarding the functioning components of ECMU 102. Therefore, display unit 120 will display the interior temperature of vehicle 100 as measured by temperature sensor 110. Temperatures may be displayed in any unit or system for temperatures, including but not limited to Celsius or Fahrenheit.

Audio-visual system 108 is included in ECMU 102. Audio-visual system 108 may include any one of a camera and or video recording device. Accordingly, ECMU 102 may also visually display the rear section of vehicle 100 when ECMU 102 is positioned to face the rear section of vehicle 100, thus providing an advantage to user 100 who desires to have a means of visually seeing the rear section of vehicle 100 under circumstances where a car seat with a child or infant is included in vehicle 100.

Audiovisual system 108 may be configured to include photographic and video recording technology with sound amplifying technology and visual recording capabilities known to one of ordinary skill in the art. Thus, audiovisual system 108 may include cameras, video-recorders, and additional microphones and speakers, without limitations. Audiovisual system 108 may also be configured to be activated remotely using user devices 126 to see and hear into an interior of user 104, while viewing the interior of vehicle 100 using user devices 126.

Audiovisual system 108 may also be configured to transmit an image of the interior of vehicle 100 to user 104 when the method described herein for alerting a user of dangerous conditions existing within vehicle 100 when an occupant, such as occupant 140, is detected in the vehicle. Thus, for example, if the temperature has been detected to exceed critical levels and an occupant has been detected, in addition to sending either an alert message to a user either via telephone call, text message, or both, audiovisual system 108 may also transmit either a photograph, a video recording or both to an email or phone account associated with user 104. Thus, audiovisual system 108 assists to provide visual and auditory information about vehicle 100 to user 104 or even emergency monitoring services 136 as needed.

Audiovisual system 108 may also be utilized as an additional security system for vehicle 100. A camera associated with audiovisual system 108 may be configured to capture images of intruders who break into vehicle 100. The camera included with audiovisual system 108 may be paired with an alarm monitoring the safety of vehicle 100. If the alarm is activated, then audiovisual system 108 may be automated to take images or video or both of the interior of vehicle 100. This may assist in capturing images of any intruders who attempt to break into vehicle 100. Thus, an additional benefit offered by audiovisual system 108 as described herein is additional security and protection for vehicle 100 through use of its cameras and audio-visual recording devices that monitor the interior of vehicle 100.

An additional beneficial security feature offered by ECMU 102 is the inclusion of an infrared night vision camera. An infrared night vision camera enhances the security system provided by ECMU 102 by allowing images to be captured of the interior of vehicle 100 under dark lighting conditions such as at night. An infrared night vision camera is configured to allow people or animals to be observed without the observer being detected. The infrared night vision camera may be a component in an ECMU 102, so as to enhance the security capabilities offered by ECMU 102 in vehicle 100. The camera may also be coupled with motion detection capabilities so that the camera is automated to capture images if the camera senses any movement.

ECMU 102 includes global positioning system (GPS) 106. GPS 106 is known by one of ordinary skill in the art that operates that connects with space-based satellite systems configured to assist user 104 in both navigating roadways as well as is used to provide location coordinates. In ECMU 102, GPS 106 may be used to provide location coordinates of vehicle 100 and/or a physical address of vehicle 100. Importantly, GPS 106 may provide the actual location of vehicle 100 in circumstances whereby ECMU 102 has contacted user devices 126 because ECMU 102 has detected the presence of an occupant in vehicle 100 under hazardous environmental conditions, such as extreme heat, cold, or carbon monoxide poisoning. Microphone 112 may also be included in ECMU 102 to provide audio reception of the interior of vehicle 100. In some illustrative embodiments, microphone 112 may not be a separate component but integrated already into audiovisual system 108.

Additionally, in some embodiments of ECMU 102, carbon monoxide detector 128 is included with ECMU 102 to detect levels of carbon monoxide existing as a gas in vehicle 100, so as to prevent carbon monoxide poisoning. Carbon monoxide sensor 128 is designed to measure levels of carbon monoxide over time and may sound an alarm that is aural in the vehicle before dangerous levels of carbon monoxide may accumulate in an environment, giving people adequate warning to safely ventilate the area or evacuate. Display unit 120 may also display readings and measurements provided by carbon monoxide sensor 128 so that user 104 is aware of the level of carbon monoxide in vehicle 100. Thus, ECMU 102 has functional benefits to user 104 when user 104 is both present in vehicle 100 and even when user 104 is not present in vehicle 100. Additionally, based on the system operated by ECMU 128, an emergency monitoring service, such as emergency monitoring services 136, may be notified if dangerous levels of carbon monoxide are located in vehicle 100.

Further, power sources 130 refer to the modules of ECMU 102 that provide power to ECMU 102. These modules may be operational via various means, including, but not limited to, batteries, both rechargeable and single use, or via wired connection to the electrical charging unit readily available in most vehicles, such as vehicle 100. Wireless power is also a type of technology available to one of ordinary skill in the art and may be used in conjunction with power sources 130 to power ECMU 102.

In a preferred embodiment, ECMU 102 is powered through a combination of battery power and solar power. In a preferred embodiment, ECMU 102 has batteries that may be powered through either electrical or solar power, and thus may be configured to store solar energy that ECMU 102 is exposed to by its location within vehicle 100. Nothing herein, however, is meant to limit ECMU 102 to solely battery or solar power. Additionally means include wired or wireless power available to one of ordinary skill in the art. ECMU 102 may display the level of power held by ECMU 102 using a visual means of display to indicate to user 104 whether ECMU 102 needs additional power.

ECMU 102 is configured to be powered whether vehicle 100 is powered on or off. User 104 has the option to power off ECMU 102 during times when user 104 is in the vehicle. In some embodiments, ECMU 102 is configured to automatically power on, if it had been powered off, as soon as vehicle 100 is powered off. This embodiment provides an added security feature whereby ECMU 102 is operational during a critical period when user 104 may have left vehicle 100 and ECMU 102 may be used to monitor any critical conditions within vehicle 100.

In another illustrative embodiment, while user 104 is within vehicle 100, ECMU 102 may be set in an operational mode whereby the notification component of ECMU 102 is disabled while user 104 is within vehicle 100. It is assumed that while user 104 is located within vehicle 100 that an occupant would not be under danger of a critical condition that user 104 is unaware of. Instead, while user 104 is driving vehicle 100 or parked or remaining within the interior of vehicle 100, ECMU 102 may be, deactivated, so that ECMU 102 is not sending unnecessary alert messages to user devices 126 while user 104 is within vehicle 100.

Accordingly, in some illustrative embodiments, ECMU 102 may be configured to be set in an active mode and an inactive mode. In one illustrative embodiment, inactive mode is a setting that user 104 may manually select on display unit 120. Inactive mode allows user 104 to temporarily disable the notification messages that would normally be sent to user 104 if ECMU 102 detects a temperature has reached a threshold level within vehicle 100. Usually, inactive mode is selected because user 104 is located within vehicle 100 as well as occupant 140, thus presenting no danger to occupant 140 of being left unattended under critical circumstances.

In other illustrative embodiments, inactive mode may also be automatically enabled by ECMU 102 so that ECMU 102 automatically detects when a vehicle, such as vehicle 100, is being driven or otherwise in use by user 104 while user 104 is within vehicle 100. This advantage offered by ECMU 102 serves to prevent unnecessary messages from being transmitted and possibly alerting emergency services when there is not the same level of concern of a critical environmental condition harming occupants residing within a vehicle, since user 104 is also present in vehicle 100 and may use other means to adjust the environmental conditions in a vehicle, such as opening or closing windows or powering on the heat or air conditioning.

When ECMU 102 includes carbon monoxide sensor 128, carbon monoxide sensor 128 remains enabled at all times, even when the notification messages from temperature sensor 110 are temporarily disabled on ECMU 102. This configuration prevents carbon monoxide poisoning for both user 104 and other occupants, such as occupant 140, driving or otherwise located within vehicle 100.

ECMU 102 is configured to take regularly programmed readings of temperature within vehicle 100 using temperature sensor 110. Temperature sensor 110 displays the most current temperature taken of the interior of vehicle 100 on display unit 120. This illustrative embodiment allows ECMU 102 to be used as a monitoring device that is configured to connect with user devices 126 and provide additional security for user 104, in addition to monitoring the temperatures of a vehicle if an occupant is present or detecting carbon monoxide and notifying user 104 of these hazardous conditions to occupants in vehicle 100.

Cellular communications unit 118 is configured to connect with microcontroller 116 in order to provide notifications of the conditions existing within vehicle 100 to user 104 and/or set of individuals 132. In a preferred embodiment, cellular communications unit 118 is configured to utilize GSM technology. GSM is an abbreviation for Global System for Mobile communications. GSM is a standard developed by the European Telecommunications Standards Institute (ETSI) to describe protocols for second generation (2G) digital cellular networks used by mobile phones. It is the default global standard for mobile communications with the vast majority of markets accessible to GSM, and at this point in time, is available in over 219 countries and territories. GSM is a cellular network. Benefits of GSM technology include that GSM is supported by both indoor and outdoor cellular networks. Thus, ECMU 102 may provide notifications to user 104 regardless of the proximity of user 104 to vehicle 100 and regardless of whether vehicle 100 is located within a parking garage or other enclosed structure.

However, nothing herein restricts cellular communications unit 118 to operate solely over GSM. Other networks may include CDMA cellular technology and other systems as available to one of ordinary skill in the art. CDMA is an abbreviation for code division multiple access. CDMA is a channel access method used by various radio communications technologies. Cellular communications unit 118 may be configured to operate over any cellular communications system that enables communication over communications network 124 to user devices 126. User devices 126 may include, without limitation, electronic smart phones, computers, tablets, as well as accessing communication receivers for police and fire departments 138 and emergency monitoring services 136. Cellular communications unit 118 is a component of ECMU 102 configured to operate over a network to connect to user devices 126 over a relevant cellular network. If cellular communications unit 118 is a GSM operated unit, then the system may be that of a type of GSM enabled radio, in which case, the GSM radio is configured to communicate with base transceiver stations (BTS) and base station controllers (BTC), and manage the radio link between phones and other devices linked to the GSM telecommunications core network.

In an illustrative embodiment, microcontroller 116 is configured to store and interpret the measurements taken by temperature sensor 110 and carbon monoxide sensor 128. Microcontroller 116 also processes the various other functions of the components integrated into ECMU 102, such as, GPS 106, microphone 112, and audiovisual system 108.

In an illustrative embodiment of one method of operation for detecting and notifying responsible parties of conditions within vehicle 100 that have reached a critical point, the following is described. In one embodiment, infrared sensor 114 detects radiation emitted from an occupant located in car seat 122. Infrared sensor 114 provides this data to microcontroller 116 that an occupant has been detected within vehicle 100.

Microcontroller 116 verifies data provided by temperature sensor 110 regarding the current temperature reading within the interior of vehicle 100. If the current temperature measurements, as provided by temperature sensor 110, are above or below a predetermined level known as a threshold level, then microcontroller 116 initiates a process for notifying user 104 using cellular communications unit 118 over communications network 124.

Communications network 124 connects to cloud computing network 144 and relays any data obtained by ECMU 102. Cloud computing network then contacts user devices 126, which are a set of electronic devices that are configured to operate with cellular networks and cellular technology. Such electronic devices, include without limitation, mobile phones, electronic tablets, computers, and other telecommunication devices commonly known to one of ordinary skill in the art. Cloud computing network 126 is composed of groups of remote servers and software networks that allow for centralized data storage of data obtained from ECMU 102, online access to computer services or resources, as well as communication capabilities to contact user devices 126 to notify user 104 of conditions existing in vehicle 100.

In some future embodiments, ECMU 102 may also directly contact user devices 126 without transmitting to cloud computing network 144. A preferred embodiment, however, is that ECMU 102 transmits information to cloud computing network 144, which then has the responsibility to provide alert message 134. Furthermore, in a preferred embodiment, cloud computing network 144 can receive data and/or messages from ECMU 102, interpret the communication or data, as well as generate any necessary alert messages, such as alert message 134. Additionally, cloud computing network 144 is enabled to assemble data and make a determination to alert any one of at least user 104, emergency monitoring services 136, and police and fire departments 138.

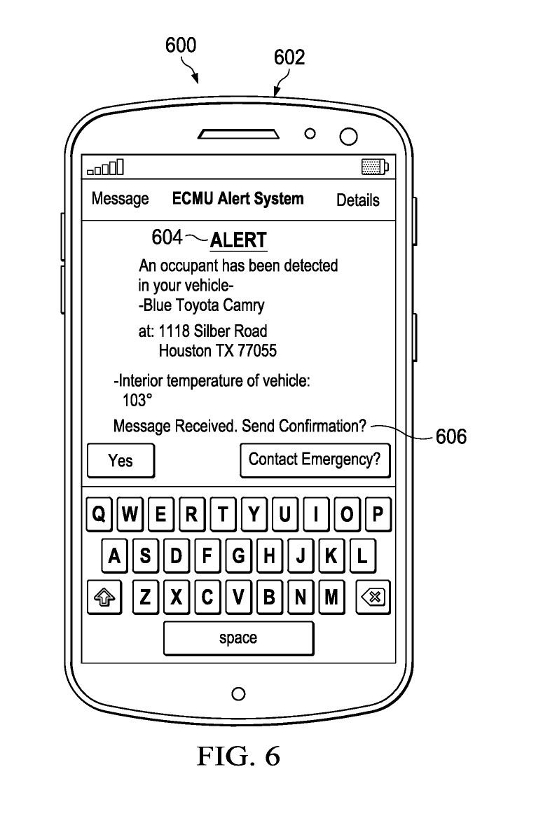

The communication provided to user devices 126 is also seen in FIG. 1 as alert message 134. In some embodiments, alert message 134 may be a phone call with a voice recording or live voice message for the recipients of alert message 134. A preferred embodiment of the method herein is for a phone call to be made to user devices 126 so as to ensure the communication is received by user 104. In another embodiment, alert message 134 may be a text based communication that may be received on user devices 126, as seen in FIG. 6. In one illustrative embodiment, alert message 134 indicates to the recipients of alert message 134 that an occupant has been detected in vehicle 100, the current temperature measurement in vehicle 100, the time of day that this temperature measurement has been taken, and the location of vehicle 100, based off of the data obtained from GPS 106. FIG. 6 displays a pictorial illustration of such an alert message. Alert message 134 may be configured to include other information such as whether there is any presence of any carbon monoxide within vehicle 100, as determined by carbon monoxide sensor 128. In some embodiments, alert message 134 may also transmit a visual image of the rear of vehicle 100 as captured by camera 108 or an audio-visual recording captured immediately prior to transmitting alert message of the interior of vehicle 100 as visible to audio-visual system 108.

A preferred method is for alert message 134 to be delivered as a phone call to one or more phones associated with user 104, to ensure that user 104 receives the phone call in a timely manner. The method described herein requests confirmation that user 104 has received alert message 134 in order for the system to stop attempting to contact user 104 over its various user devices 126. Cloud computing network 144 may thus attempt to send an alert message 134 to user 104 via phone and email notification as well as text, if the first attempt to provide a phone call is unsuccessful in obtaining a confirmation from user 104 that he or she has received alert message 134 regarding conditions in vehicle 100.

When ECMU 102 is configured, user 104 is asked to provide preferred contact telephone numbers and email addresses to be associated with user 104's account. Thus, when cloud computing network 144 attempts to reach out to user 104, it is able to via the recorded and registered contact information. An account and profile for user 104 is associated with a service that acts to monitor ECMU 102 data. Utilizing cloud computing network 134 via communications network 124, alert message 134 is distributed to recipients that have been pre-programmed to be contacted via ECMU 102. These recipients may include user 104. ECMU 102 may also be programmed to communicate alert message 134 to additional parties responsible for vehicle 100. These recipients may include family members and friends associated with user 104. Set of individuals 132 may also include family members and friends associated with user 104.

In one preferred embodiment, user 104 is asked for confirmation of receipt of alert message 134 within a predetermined amount of time. For example, upon transmitting alert message, alert message 134 includes a selection that allows user 104 to provide confirmation back to ECMU 102 that alert message 134 has been received. If a specified amount of time has passed, whereby no confirmation has been provided to ECMU 102 that alert message 134 has been received, then ECMU 102 may transmit alert message 134 has a follow up message to set of individuals 132. ECMU 102 will include a specified amount of time programmed into microcontroller 116 and in some embodiments, user 104 may determined the specified amount of time for which user 104 should send a confirmation after having received alert message 134.

In one embodiment, ECMU 102 may also transmit a call requesting assistance for vehicle 100 with the accompanying coordinates to police and fire stations local to vehicle 100, seen in FIG. 1, as police and fire stations 138.

It is intended that if ECMU 102 transmits a communication such as alert message 134, user 104 will be the first to receive alert message 134, and will provide confirmation that alert message 134 has been received. If a confirmation is received by ECMU 102, then ECMU 102 does not contact additional parties, unless requested by user 104 to also send additional parties an alert message.

FIG. 1 illustrates that additional parties other than user 104 may be contacted regarding hazardous conditions in vehicle 100 such as emergency monitoring services 136 and police and fire departments 138. Emergency monitoring services 136 embody any private emergency monitoring service associated with ECMU 102. Emergency monitoring service 136 provides safety and monitoring services for user 104. Emergency monitoring service 136 may be a service package subscribed to by user 104 or may be automatically attached as a service to the purchase of ECMU 102 by user 104. Emergency monitoring service 136 may be utilized by user 104 to request any emergency assistance for user 104 whether user 104 is located within vehicle 100 or whether user 104 is elsewhere. Police and Fire Departments 138 represent various local and state administered police and fire departments that may also be alerted if user 104 does not respond to alert message 134 within a designated amount of time, and an occupant has been detected to be located within vehicle 100 under potentially critical conditions. By returning confirmation of receipt, then ECMU 102 does not contact additional parties, such as either set of individuals 132 or emergency monitoring service 136 or police and fire stations 138.

In one embodiment of the accompanying method, ECMU 102 registers the confirmation and does not attempt to scan the interior of vehicle for occupants for a specified range of time. For example purposes only, once user 104 has provided confirmation of receipt of alert message 134, ECMU 102 may be configured not to send further notifications of an occupant for 15 minutes, thus allowing user 104 this period of time to return to vehicle 100 and assist any occupants located in vehicle 100 that user 104 has now been alerted to by alert message 134.

In circumstances whereby occupant 140 is not a human child or human infant, but rather, an animal, such as a pet, ECMU 102 may also be utilized to notify user 104 when conditions within vehicle 100 may be dangerous to that pet. Pets may be any type of animal known to one of ordinary skill to be owned by people, including dogs, cats, and other animals. As previously discussed, infrared sensor 114 detects radiation emitted by animate objects, including animals. When occupant is an animal that is within the field of view of infrared sensor 114, then infrared sensor 114 detects the presence of this animal as occupant 140. If microcontroller 116 detects the presence of the animal, usually because animals may be moving back and forth in the rear of a vehicle, such as vehicle 100, then microcontroller verifies the conditions of the interior of vehicle 100. If the current interior temperature of vehicle 100, exceeds predetermined levels, then ECMU 102 initiates the same procedure as above-described regarding the occupant in car seat 122 to send an alert message to user 104.

In some embodiments, ECMU 102 may also be configured to activate vehicle 100 so that vehicle 100 may be powered on remotely, including turning on air conditioning or rolling down windows in vehicle 100 to assist occupant 140 if the temperature has been detected as being critically high. Alternatively, vehicle 100 may be powered on for activating heating in vehicle 100 if temperature has been determined to be critically low. The service associated with monitoring vehicle 100 through ECMU 102 thus allows for remote activation and control of various components of vehicle 100 to assist occupant 140 even when user 104 is not directly located within vehicle 100.

Thus, an illustrative embodiment is presented for detecting and notifying a user or set of relevant individuals regarding the presence of occupants in a vehicle under potentially critical or hazardous conditions. The module seen in FIG. 1, ECMU 102, has versatility and accommodates multiple vehicles that its user, such as user 104, may operate at any time. Because ECMU 102 does not require a specific sensor to be attached to a car seat, ECMU 102 may be transferred from vehicle to vehicle and used as needed by user 104. It is envisioned that parents may utilize ECMU 102 for prevention of fatalities due to various dangerous environmental conditions that may exist at some point in time in vehicles to their young children who may be forgotten in vehicles. Pet owners are also envisioned as using ECMU 102 to prevent any such fatalities or injuries to their pets. User 104 is not limited to parents and or pet owners but may include any individual responsible for any occupants of interest, including school administrators, bus drivers, taxi drivers, and any party who may benefit from using ECMU 102.

Another advantage offered by ECMU 102 is that ECMU 102 communicates with user 104 or a set of individuals 132 over a range of distance, which is an advantage provided by use of cellular communications unit 118 and transmitting communications over communications network 124. Additionally, ECMU 102 may have independent power sources 130 that do not require the vehicle to be powered on to operate. Another beneficial component of ECMU 102 is that audiovisual system 108 may provide audio-visual feedback to user 104 of the interior of vehicle 100. ECMU 102 may be connected to emergency monitoring services 136, which acts as a service for providing emergency assistance and notifications to other individuals as needed by user 104.

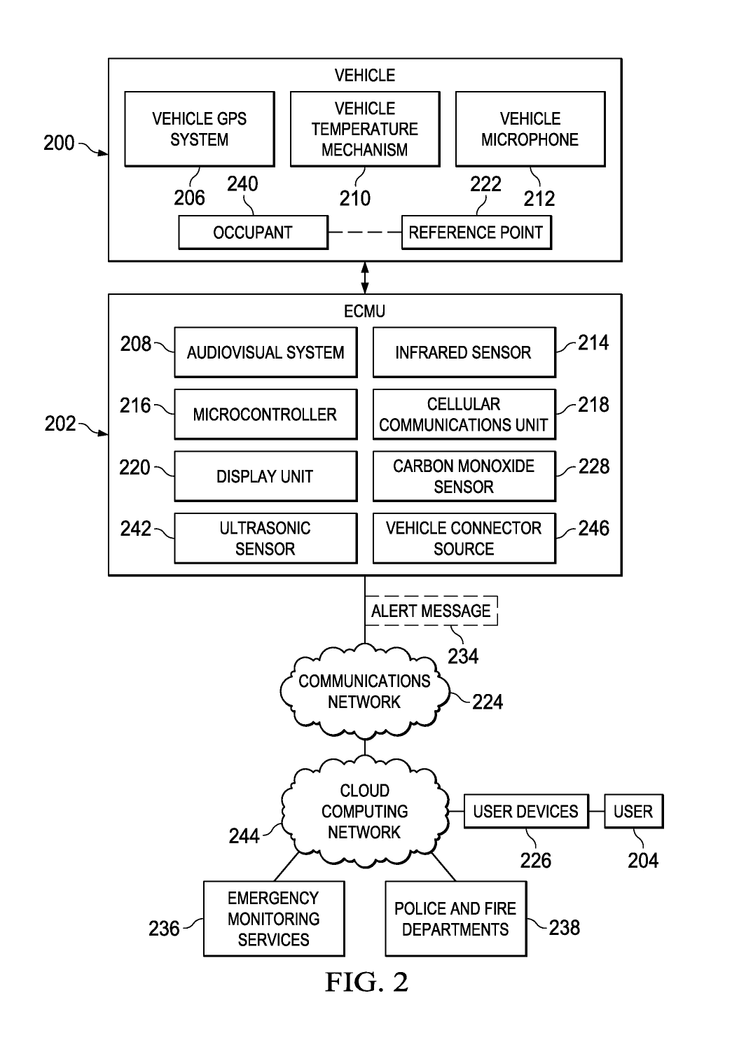

FIG. 2 is a block diagram of an environmental condition monitoring unit that operates in conjunction with integrated functional elements existing within a vehicle in accordance with an illustrative embodiment. In the embodiment of ECMU 202, ECMU 202 is configured to interpret data from components already integrated into the structure of vehicle 200. Furthermore, vehicle manufacturers, dealers, or retailers may install and associate a monitoring device, such as ECMU 202 to operate in conjunction with the various units and systems existing within their vehicles. Such vehicle manufacturers, dealers, or retailers may then offer for sale their vehicles to a user, such as user 204, with the additional benefits and advantages provided by having ECMU 202 existing within vehicle 200 at the time of sale to user 204. Nothing herein precludes user 204 from individually choosing to purchase and install ECMU 202 in vehicle 200 on his or her own initiative.

Furthermore, FIG. 2 illustrates that ECMU 202 may be configured to operate its method of conveying data to a user associated with ECMU 202 by also operating with various other existing systems within vehicle 200. These other existing systems may have been manufactured to operate to operate within the vehicle from the initial manufacture of vehicle 200 or these systems may be after-market installations or additions made after initial manufacturing of vehicle 200.

FIG. 2 illustrates three exemplary systems configured to operate with ECMU 202. These illustrated three systems are vehicle GPS system 206, vehicle temperature mechanism 210, and vehicle microphone 212. This is one exemplary embodiment of how ECMU 202 may be configured to operate alongside with existing systems in vehicle 200. Notwithstanding FIG. 2, nothing herein is meant to limit ECMU 202 from alternate configurations or embodiments that operate with other non-illustrated vehicular systems in FIG. 2. These additional systems within vehicle 200 that may be associated with ECMU 202 may include, but are not limited to, various vehicular security alarm systems, vehicular audiovisual systems, vehicle gauges, vehicle sensory devices that measure various conditions in vehicle 200, and vehicle telephone communications systems.

Accordingly, ECMU 202 may provide notifications to user 204 of various conditions within vehicle 200 by operating in conjunction with existing vehicular systems. Several advantages are provided by such a configuration of ECMU 202. Car manufacturers or dealers may provide additional features with their already existing systems that ECMU 202 may capitalize on. Additionally, an advantage of such an embodiment of ECMU 202 is a reduction in the amount of systems that may need to be pre-installed or manufactured to operate on ECMU 202 as separate units from vehicle 200, thus potentially reducing power usage by ECMU 202.

Thus, in an illustrative embodiment illustrated in FIG. 2, vehicle microphone 212, vehicle GPS 206, and vehicle temperature mechanism 210 are integrated components of vehicle 200. When user 204 purchased vehicle 200, these components are existing within vehicle 200 and capable of use in conjunction with ECMU 202. ECMU 202 and vehicle 200 in FIG. 2 are exemplary illustrative embodiments of an ECMU used in combination with systems within a vehicle, such as vehicle 200.

Vehicle microphone 212 functions as a microphone capable of amplifying sound. Vehicle GPS 206 functions as a global positioning system capable of providing navigational and instructions as well as geographic data about the geographic location of vehicle 200. Vehicle temperature mechanism 210 is a temperature gauging mechanism for measuring and recording the interior temperature of vehicle 200. These listed components envisioned as already existing within the structure of vehicle 200 are listed for example purposes only and not as a limitation on any other components of vehicle 200 that may be configured to operate in conjunction with the system and function of ECMU 202. As previously stated, nothing herein limits other embodiments of ECMU 202 from being associated with additional existing systems within vehicle 200.

In an illustrative embodiment, ECMU 202 has a vehicle connector source 246, which operates as a port that connects to vehicle 200. Vehicle connector source 246 allows for data collected by vehicle microphone 212, vehicle GPS system 206, and vehicle temperature mechanism 210 to be transmitted to microcontroller 216.

Microcontroller 216 is then able to interpret and use data obtained from these integrated vehicle components in conjunction with the components of ECMU 206 for detecting critical environmental conditions within vehicle 200 and notifying user 204. Microcontroller 216 operates as microcontroller 116 described in FIG. 1.

In FIG. 2, ECMU 202 includes infrared sensor 214, ultrasonic sensor 242, and carbon monoxide sensor 228, which operate in accordance with the functional capabilities of infrared sensor 114, ultrasonic sensor 142, and carbon monoxide sensor 128 as seen above in FIG. 1. Thus, ECMU 202 as embodied in FIG. 2 operates in conjunction with components that may already be integrated in a vehicle. ECMU 202 may be separately purchased by user 204 and attached through permanent or semi-permanent means to the interior of vehicle 200. Display unit 220 may provide visual feedback to user 204 of the settings and data associated with the various components connected to ECMU 202 as well as the embedded components of ECMU 206.

Audiovisual system 208 may operate in accordance with audiovisual system 108 as described in FIG. 1. Accordingly, audiovisual system 208 may include cameras, video recording devices, and other devices that allow user 204 to see and hear at any time, using remote devices such as user devices 226, into the interior of vehicle 200 where occupant 240 is located. Audiovisual system 208 may further include a night vision infrared camera to capture images for security purposes of vehicle 200 at night. Audiovisual system 208 may provide images in real-time of occupant 240 at any time as requested by user 204.

When a user purchases ECMU 202, he or she may position ECMU 202 in relation to the appropriate range or field of view of occupant 240 so that the embedded infrared sensor 214 is correctly positioned in vehicle 200 in relation to the appropriate field of view of occupant 240.

It is envisioned that ECMU 206 operates in a method similar to that method as described in FIG. 1 to detect any dangerous conditions as well as the presence of an occupant in vehicle 200. Microcontroller 216 interprets data provided by vehicle temperature mechanism 210 over a specified regular interval of time. ECMU 202 is programmed to store critical levels associated with vehicle temperatures. If ECMU 202 determines that a critical threshold as been reached with respect to the interior temperature of vehicle 200 and occupant 240 has been detected, whether by use of infrared sensor 214 or ultrasonic sensor 242, ECMU 202 may proceed to send an alert message to cloud computing network 244 through cellular communication unit 218. Cloud computing network 244 transmits the alert message 234 initially to user devices 226. If a user provides confirmation that alert message 234 has been received, the system ceases to send further alert messages. In cases where no confirmation is received by cloud computing network 244 after a specified period of time, alert message 234 may be retransmitted to additional devices or accounts, and even to police and fire departments 238 or emergency monitoring services 236. Accordingly, ECMU 202 operates in conjunction with some existing components within vehicle 200 to provide the same monitoring and alert notification system and method as described in FIG. 1.

In some scenarios, the configuration of ECMU 202 allows for car manufacturers to integrate the functions and capabilities of ECMU 202 with existing functional components of their cars and vehicles. Thus, a car manufacturer or dealer may be able to provide a user who purchases a vehicle with an ECMU unit, such as ECMU 202, as an add-on feature desired by a user.

FIG. 3 is an illustration depicting an environmental condition monitoring unit such as ECMU 102 as described in FIG. 1. In FIG. 3, a perspective view of vehicle 300 is depicted. In FIG. 3, temperature display is included as a component of ECMU 304, and indicates that the temperature within the interior of vehicle 300 has reached 103 degrees Fahrenheit. The temperature illustrated herein is only meant for example purposes only and not intended to be the only threshold temperature utilized by ECMU 102 or 304.

FIG. 3 also illustrates the presence of occupant 308. Occupant 308 is illustrated to be a young child present in car seat 310 in the vehicle without an adult or other guardian present. Because ECMU 302 is configured to detect occupant 308 using an embedded infrared sensor located within the structure of ECMU 304, ECMU 304 may contact a relevant user associated with vehicle 300 and notify them of the presence of occupant 308 within vehicle 300 in critical high heat conditions whereby the vehicle's interior has reached 103 degrees Fahrenheit.

Field of view 306 refers to the field of view associated with the infrared sensor embedded within ECMU 306. ECMU 304 has been attached, through either semi-permanent or permanent means as desired by the user, to the interior windshield of vehicle 300. ECMU 304 in FIG. 3 may not be shown to actual size, but as an example of a possible appearance of ECMU 304. ECMU 304 may be of a variety of sizes, heights, widths, shapes, and include different combinations of user controls to interface with ECMU 304 as needed. ECMU 304 has been attached so that field of view 306 is within a specific distance and field of view of car seat 310 that is compatible with the infrared sensor embedded in ECMU 304. As previously described in FIG. 1, an embedded infrared sensor detects radiation emitting from animate objects within a certain range and field of view of the infrared sensor. Depending on the strength and technology available to the infrared sensor, the infrared sensor in ECMU 304 may have any range of distance and/or field of view within which it operates from a reference point such as car seat 310.

In FIG. 3, once ECMU 304 determines that occupant 308 is present in vehicle 300 and that the temperature has reached a critical level, ECMU 304 may proceed to notify relevant parties of the presence of occupant 308 so as to initiate the aid, assistance, and rescue of occupant 308 from vehicle 300.

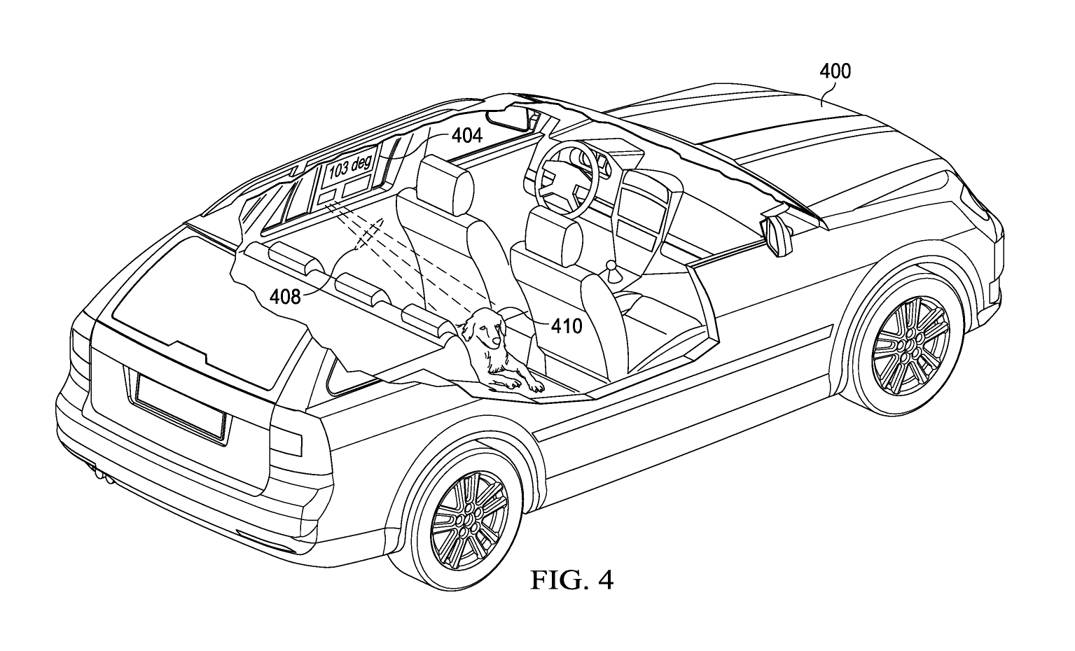

FIG. 4 is a pictorial illustration of a vehicle whereby the occupant within the vehicle is a pet and the environmental condition monitoring unit is included in accordance with an illustrative embodiment. ECMU 404 functions and operates as an environmental condition monitoring unit in accordance with the descriptions thereof in FIGS. 1-3. ECMU 404 is displayed for illustrative purposes only, and nothing herein is meant to limit the physical appearance of ECMU 404 to that portrayed in FIG. 4. ECMU 404 may be of varying sizes and combinations of user controls on its interface. In FIG. 4, ECMU 404 is positioned on the side rear passenger window of vehicle 400. ECMU 404 is thus located near the rear row of seats where occupant 410 is located.

FIG. 4 illustrates that an environmental condition monitoring unit may be placed anywhere within the vehicle to accommodate the needs of the user. ECMU 404 has an embedded infrared sensor that detects radiation emitted from living objects within vehicle 400. In another embodiment, ECMU 404 may also include other types of sensors for detecting occupant 410, including an ultrasonic sensor, such as ultrasonic sensor 142, described in FIG. 1.

Occupant 410 is depicted as the user's pet, which in FIG. 4 is a dog. Pets may be detected whether they are unrestrained within the vehicle, as seen in FIG. 4, or whether they are restrained within an enclosure for transporting pets within vehicles. The embedded infrared sensor existing within ECMU 404 is configured to detect the radiation emitted from animals as well as humans.

ECMU 404 is illustrated as having field of view 408. As described in FIGS. 1-3, the infrared sensor is positioned in a manner so that the embedded infrared sensor is functional within a certain range and distance from the general vicinity of occupant 410.

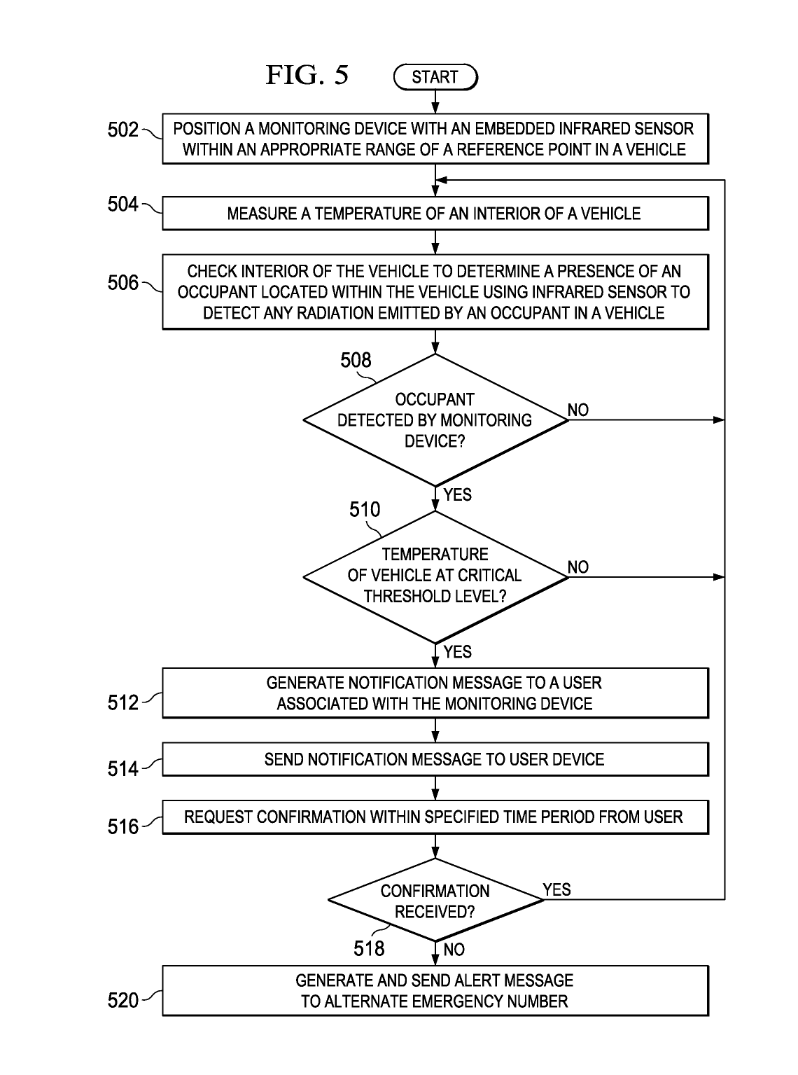

FIG. 5 is a flowchart illustrating a process for detecting and notifying a user or other set of responsible individuals associated with a vehicle of occupants present in the vehicle under certain environmental conditions, especially those conditions that are hazardous to the health of the occupants in the vehicle.

The process begins by positioning a monitoring device with an embedded infrared sensor within an appropriate distance from a reference point in a vehicle (step 502). A temperature is measured of an interior of the vehicle (step 504). The process next determines whether there is a presence of an occupant within the vehicle using the infrared sensor to detect any radiation emitted by an occupant in the vehicle (steps 506 and 508). If no, then the process ends. If yes, then the process determines whether the most recent collected temperature within the interior of the vehicle has reached a threshold temperature for notifying a responsible party (step 510). The process then generates a notification message to a user associated with the monitoring device (step 512). The notification message is sent to at least one electronic device associated with the user (step 514). The notification message may be a text message containing pertinent information regarding the vehicle where the occupant has been detected. Additionally, the notification message may be transmitted as a phone call or other means of audiovisual notification to a user.

The process then proceeds to request confirmation to be provided within a programmed amount of time (step 516). After a pre-determined period of time, the process verifies whether a confirmation is received by the monitoring device from the original recipient of the alert message (step 518). If a confirmation is not received, then an alert message may be generated and sent to an alternate emergency number (step 520). In some cases, the monitoring device may contact in a predetermined order any other numbers associated with a user or other responsible parties associated with a user's account. The monitoring device may also contact an emergency monitoring services and/or police and fire departments, In one illustrative embodiment, the process ends by returning to step 504 to measure the temperature within the vehicle when the user provides confirmation of having received the notification message. Thus, the environmental condition monitoring unit is constantly monitoring the conditions within the vehicle. Once confirmation is received, however, the environmental condition monitoring unit may be directed not to send any further alert messages to the user for a specified period of time until occupant has been removed safely from the vehicle. In other illustrative embodiments, more actions may be initiated by the user as seen in FIG. 6 below. For example, the vehicle may be powered on remotely or the air conditioning activated remotely.

In some alternative implementations, the functions noted in the steps of the flowchart shown in FIG. 5 may occur out of the order noted in FIG. 5. For example, two steps shown in succession may, in fact, be executed substantially concurrently, or the steps may sometimes be executed in the reverse order, depending upon the functionality involved.

FIG. 6 provides an illustration of a notification message provided to a user of a critical condition in a user's vehicle in accordance with an illustrative embodiment described herein. In FIG. 6, a text message has been provided to user's phone 602, which may be an example of a user device, as seen in FIG. 1 as user devices 126. A notification message regarding a critical condition in a vehicle may also be transmitted via alternative means, such as email or phone, and transmitted to more than one device associated with a user. Accordingly, for example, an alert message may also be transmitted simultaneously to a user's email account associated with an ECMU.

In FIG. 6, an example of a notification message that may be transmitted to a user is presented. It is understood that one of ordinary skill in the art may provide various substitutions, changes, and alterations to the types of notification messages received by a user and the content of these notification messages without departing from the scope of the invention.

In one illustrative embodiment, alert message 604 includes a text message sent to user's phone 602 stating that an occupant has been detected in a user's vehicle. Alert message 604 includes identifying features for the user's vehicle, such as the make and model of the vehicle that is associated with the ECMU monitoring that particular vehicle. Additionally, alert message 604 includes an address where the vehicle is located as well as the interior temperature reading within the vehicle.

Confirmation message 606 requests that a user either send a confirmation that alert message 604 has been received and/or asks a user to contact an emergency number. If the user chooses to contact emergency, various actions may occur. In one illustrative embodiment, if the user's device is a phone, such as user's phone 602, then the phone may proceed to dial an emergency number such as 911, thus allowing the user to speak with emergency immediately and directly. In another embodiment, there may be another emergency monitoring service associated with the ECMU monitoring a user's vehicle, and by selecting “Contact Emergency” key as seen in confirmation message 606, that particular emergency monitoring service is contacted.

In some embodiments, existing technology for automatically powering on a vehicle remotely may also be activated, which may allow a user to roll down windows in a vehicle remotely or begin air conditioning in a vehicle. Accordingly, various combinations of resulting actions may be programmed to operate with an environmental condition monitoring unit after a notification message has been sent and confirmed by a user on a user's device.

As described above, in an illustrative embodiment, a monitoring device is positioned within an interior of a vehicle. The monitoring device is intended to at least detect occupants in a vehicle when interior temperatures reach above or below a threshold temperature considered to be a critical level for an occupant's health. The occupants are oftentimes young children, infants, and pets that have been forgotten in a user's vehicle when temperatures reach extreme levels. The monitoring device includes an infrared sensor that detects occupants using infrared technology that detects radiation emitted from the occupants. The monitoring devices also are configured to notify at least a user associated with the monitoring device with a notification message. The monitoring device may also request confirmation and send notification to alternate emergency numbers to assist the occupants located within the vehicle.

The figures herein demonstrate a few of the advantages of the presently described system and apparatus. In some illustrative embodiments, the environmental condition monitoring units are provided with various components that are functional and beneficial to a user to have within his or her vehicle, such as at least a camera, temperature sensor, GPS system, and carbon monoxide sensor. The environmental condition monitoring units also connect via a GSM system to telecommunications network readily available virtually in every location. Additionally, the environmental condition monitoring units offer versatility of placement and means of attachment to the interior surfaces of a vehicle. Prior art in this field has been hampered by restrictive designs that require cumbersome sensors on car seats or enclosures within vehicles. In the very limited existing options available in the prior art, a user had to choose a single vehicle to locate a monitoring device. Alternatively, the illustrative embodiments herein provide flexibility to the user in that they may be taken to different vehicles as needed by the user. Oftentimes, in situations where a young child, pet, or other loved one has been forgotten in vehicles, the responsible parent or guardian has changed his or her routine in some way, and thus forgets in a new vehicle of the presence of the occupant in the vehicle. If a user is able to transfer the environmental condition monitoring units to each vehicle that a user may be driving in for the day, then this will reduce the risk of a tragedy or fatality since the environmental condition monitoring unit should notify the user of the occupant in this different vehicle. The mere fact that a user remembers to include the environmental condition monitoring unit may serve to prevent any neglect or accidental forgetting of loved ones in vehicles because the user is more alert to the potential situation arising in the first place.

The installation and configuration of the environmental condition monitoring units is not labor intensive or difficult to implement. When configuring the environmental condition monitoring unit to operate in a user's vehicle, the user is provided with a series of steps to follow to configure the device. For example, the environmental condition monitoring unit may ask the user to specify the type of vehicle that the environmental condition monitoring unit is presently located in, so that when an alert message needs to be sent to the user, the alert message may contain the type of vehicle where the occupant has been detected. Such an embodiment assists the user in recollecting which vehicle the occupant may be located in.

Further steps may be provided to a user who has attached the environmental condition monitoring unit in a vehicle to determine the field of view of the monitoring unit is correct in relation to the location of a car seat or certain known occupants in user's vehicle. Accordingly, in one illustrative embodiment, the user may select buttons or indicators located on the display of the environmental condition monitoring unit to conduct a test of the infrared sensor embedded in the environmental condition monitoring unit. The test serves to detect an occupant located in a rear car seat of a user's vehicle under regular conditions when the user of the vehicle is also present, so that, if successful in detecting the occupant of interest, then the user can confirm that the placement of the monitoring unit is correct with respect to the occupant. Thus, the environmental condition monitoring unit offers advantages in terms of flexibility of use, ease of installation and removal, as well as additional detection and security elements not seen in any of the limited prior art options presently available.

The detailed description of the illustrative embodiments above is described in sufficient detail to enable those skilled in the art to practice the invention. To avoid unnecessary detail, the description may have omitted certain information known to those skilled in the art.

Although the illustrative embodiments described herein have been disclosed in the context of certain illustrative, non-limiting embodiments, it should be understood that various changes, substitutions, permutations, and alterations can be made without departing from the scope of the invention as defined by the appended claims. Any feature that is described in connection to any one embodiment may also be applicable to any other embodiment. It is also understood that other embodiments may be utilized and that logical structural, mechanical, and chemical changes may be made without departing from the spirit or scope of the invention.

What is claimed is:

1. A method for notifying a user regarding a critical condition in a vehicle, the method comprising:
positioning a monitoring device on a surface of a vehicle within an appropriate range of distance from a reference point in the vehicle, wherein the monitoring device further includes an infrared sensor;
measuring a temperature of an interior of the vehicle, wherein the monitoring unit measures the interior of the vehicle using a temperature sensor;
verifying whether an occupant is located within the vehicle, wherein the infrared sensor is used to detect radiation emitted by the occupant;
upon determining the presence of the occupant, verifying whether the temperature of an interior of the vehicle is at a threshold temperature;
upon detecting the presence of the occupant within the vehicle and upon determining that the temperature is at a threshold temperature, generating a notification message to a user associated with the monitoring device, wherein the notification message is delivered to an electronic device associated with the user; and
requesting confirmation from the user that the notification message is received, wherein if no confirmation is provided within a predetermined amount of time, generating and sending an alert message regarding a presence of the occupant within the vehicle to an alternate emergency number associated with the monitoring device.

2. The method of claim 1, further comprising:
indicating to the user when the monitoring device is located within a field of view of the reference point in the vehicle, wherein the monitoring device includes a display on a surface of the monitoring device to indicate if the monitoring device is within the appropriate range of distance from the reference point for the infrared sensor to detect the occupant.

3. The method of claim 1, wherein the monitoring device communicates data collected by the monitoring device about the interior of the vehicle to a cloud computing network.

4. The method of claim 1, wherein the cloud computing network is configured to receive the data from the monitoring device, interpret the data to determine whether to contact the user, and generate an alert message to the user regarding the data obtained in real time from the vehicle.

5. The method of claim 1, wherein the cloud computing network makes a determination to provide a phone call to a device associated with the user, upon determining that the critical condition exists in association with the occupant in the vehicle.

6. The method of claim 1, wherein the monitoring device is further configured to include an ultrasonic sensor.

7. The method of claim 1, wherein the monitoring device is configured to include a carbon monoxide sensor to detect carbon monoxide within the vehicle.

8. The method of claim 1, wherein the user receives an image of the interior of the vehicle depicting the occupant as captured by an audiovisual device associated with the monitoring device.

9. The method of claim 1, further comprising providing a power source for the monitoring device, wherein the monitoring device remains powered even when the vehicle is powered off.

10. The method of claim 1, further comprising:
providing a setting for the monitoring device in a mode whereby the monitoring device does not transmit notification messages to a user during a specific period of time.

11. The method of claim 1, wherein the monitoring device is configured to send notification messages upon determining that the vehicle is stationary for a specific period of time.

12. The method of claim 1, further comprising:
associating identifying features of the vehicle with the monitoring device to assist with identifying the vehicle when the user receives the notification message.

13. The method of claim 1, wherein the monitoring device is configured to project sound and a visual image or video of the interior of the vehicle.

14. The method of claim 13, wherein the monitoring device from a set of devices associated with the user in order to display the interior of the vehicle to the user at any time and access the audiovisual devices to display the interior of the vehicle when the user is not located within the vehicle.

15. The method of claim 1, wherein the monitoring device is configured to include an infrared camera for detecting any activity within a vehicle in dark conditions, and further wherein the monitoring device captures images of the interior of the vehicle for security purposes.

16. The method of claim 1, wherein the power source is configured to utilize battery power, as well as solar power to recharge batteries located in the monitoring device.

17. The method of claim 1, wherein a global positioning system (GPS) is included in the monitoring device, and wherein the global positioning system provides a physical address identifying a location of the vehicle.

18. An apparatus installed in an interior of a vehicle for notifying a user of a critical condition in the vehicle, the apparatus comprising:
a temperature monitoring component, wherein the temperature monitoring component is configured to measure and record a temperature in the interior of the vehicle;
an infrared sensor, wherein the infrared sensor is configured to detect infrared radiation emitted from occupants within a range of the infrared sensor;
a housing assembly for the infrared sensor and the temperature monitoring component, wherein the housing assembly further includes a display unit, wherein the display unit displays information to the user regarding relevant environmental conditions within the interior of the vehicle, wherein the information further includes a temperature of the interior of the vehicle; and
a controller coupled to the housing assembly, wherein the controller is adapted to collect data associated with the infrared sensor and the temperature monitoring unit, and to transmit the data to a cloud computing network associated with the monitoring device, wherein the cloud computing network interprets the data to determine whether to send a notification of conditions within the interior of the vehicle to a user device associated with the monitoring device.

19. The apparatus of claim 18, wherein cloud computing network is configured to send the notification to an alternate emergency number associated with the user if a confirmation of the notification is not transmitted to the cloud computing device after a predetermined period of time.

20. The apparatus of claim 18, wherein the display unit further displays information regarding a power level for the apparatus.

21. The apparatus of claim 18, wherein the display is configured to indicate to a user whether the apparatus is within an appropriate range from a reference point in the vehicle for the apparatus to detect an occupant located near the reference point.

22. The apparatus of claim 18, wherein the apparatus is further configured to include an ultrasonic sensor.

23. The apparatus of claim 18, wherein the apparatus further comprises a power source for the monitoring device, wherein the monitoring device has power even when the vehicle is powered off.

24. The apparatus of claim 18, wherein the wherein the power source is configured to utilize battery power, as well as solar power to recharge batteries located in the monitoring device.

25. The apparatus of claim 18, wherein the apparatus further comprises a global positioning system (GPS), wherein the global positioning system provides a physical address identifying a location of the vehicle.

26. The apparatus of claim 18, wherein the apparatus is configured to project sound and a visual image or video of the interior of the vehicle.

27. The apparatus of claim 19, wherein the user can activate audiovisual devices associated with the monitoring device from a set of devices associated with the user in order to display the interior of the vehicle to the user at any time and access the audiovisual devices to display the interior of the vehicle when the user is not located within the vehicle.

28. A method for notifying a user regarding a critical condition in a vehicle, the method comprising:
positioning a monitoring device on a surface of a vehicle within an appropriate range of distance from a reference point in the vehicle, wherein the monitoring device further includes an infrared sensor;
associating the monitoring device with existing systems existing in the vehicle, wherein the existing systems further include a vehicle temperature mechanism operating within the vehicle for monitoring the temperature of the interior of the vehicle;
measuring a temperature of an interior of the vehicle, wherein the monitoring unit obtains data from the vehicle temperature mechanism operating within the vehicle;
verifying whether an occupant is located within the vehicle, wherein the infrared sensor is used to detect radiation emitted by the occupant;
upon determining the presence of the occupant, verifying whether the temperature of an interior of the vehicle is at a threshold temperature;
upon detecting the presence of the occupant within the vehicle and upon determining that the temperature is at a threshold temperature, generating a notification message to a user associated with the monitoring device, wherein the notification message is delivered to an electronic device associated with the user; and
requesting confirmation from the user that the notification message is received, wherein if no confirmation is provided within a predetermined amount of time, generating and sending an alert message regarding a presence of the occupant within the vehicle to an alternate emergency number associated with the monitoring device.

29. The method of claim 28, wherein associating the monitoring device with existing systems existing in the vehicle further includes associating the monitoring device with an integrated global positioning system (GPS) existing within the vehicle, wherein the monitoring device obtains data regarding the location of the vehicle by using the integrated GPS existing within the vehicle.

30. The method of claim 29, associating the monitoring device with an audiovisual system existing within the vehicle.
